(19) United States
(12) Patent Application Publication
(10) Pub. No.: US 2020/0368621 A1
(43) Pub. Date: Nov. 26, 2020

(54) COMPETITIVE GAME BASED CHARACTER DEVELOPMENT SYSTEM

(71) Applicant: Robert Moss, Fontana, CA (US)

(72) Inventor: Robert Moss, Fontana, CA (US)

(21) Appl. No.: 16/882,718

(22) Filed: May 25, 2020

Related U.S. Application Data
(60) Provisional application No. 62/852,978, filed on May 25, 2019.

(51) Int. Cl. A63F 13/537; A63F 13/814

(52) U.S. Cl. CPC A63F 13/537; A63F 13/814

(57) ABSTRACT

A competitive game based character development system is disclosed. The system comprises, generally, a proprietary software, having a user interface on a computer or a mobile device, and which may be used to facilitate the playing of a game and the earning of reward points to develop a player's character. The system may comprise a plurality of user types, and may further associate a plurality of user settings with each of such user types. In one embodiment the system may comprise a trivia game related to hip hop trivia, and through which a player may earn rewards that can be used to purchase accessories from the game's store. These accessories may then be used to improve and develop the player's character, who may be a member of the hip hop industry.

### TECHNICAL FIELD OF THE INVENTION

The present invention relates in general to software applications, and, more specifically, to a competitive game based character development system.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Competition arises whenever at least two parties strive for a goal which cannot be shared, such as where one's gain is the other's loss. It is, in general, a rivalry between two or more entities, animals, organisms, economic groups, individuals, social groups, etc., for group or social status, leadership, profit, or recognition.

A mobile app or mobile application is a computer program or software application designed to run on a mobile device such as a phone, tablet, or watch. Apps were originally intended for productivity assistance such as email, calendar, and contact databases, but the public demand for apps caused rapid expansion into other areas such as mobile games, factory automation, GPS and location-based services, order-tracking, and ticket purchases. Apps are generally downloaded from application distribution platforms which are operated by the owner of the mobile operating system, such as the App Store (iOS) or Google Play Store.

A number of game applications have been developed that allow for competition between users, whether locally or wirelessly across a digital network. Such game applications vary significantly in the types of games played and their presentation, with a number of classic games being reimagined and new games being developed. The technology available in mobile devices allows for significant reinventing of classic games, and the addition of novel aspects to the game.

One such classic game, trivia, is a type of game involving general knowledge quizzes usually played between competitors or teams of competitors. The game is meant to test the knowledge of the players about certain subjects or topics. Quizzes are usually scored in points and many quizzes are designed to determine a winner from a group of participants—usually the participant with the highest score. They may also involve eliminating those who get too many questions wrong, the winner being the last man standing.

Character creation, also character generation or character design, is the process of defining a game character or other character. Typically, a character's individual strengths and weaknesses are represented by a set of statistics. Games with a largely fictional setting may include traits such as race and class. Games with a more contemporary or narrower setting may limit customization to physical and personality traits.

There is a need in the art for a competitive game based character development system that incorporates gameplay for earning points that may be used to develop a player character. It is to these ends that the present invention has been developed.

### BRIEF SUMMARY OF THE INVENTION

To minimize the limitations in the prior art, and to minimize other limitations that will be apparent upon reading and understanding the present specification, the present invention describes a competitive game based character development system.

It is an objective of the present invention to provide a competitive game based character development system that may comprise a software application.

It is another objective of the present invention to provide a competitive game based character development system that may comprise a mobile software application.

It is another objective of the present invention to provide a competitive game based character development system that may comprise a cloud-based software application.

It is another objective of the present invention to provide a competitive game based character development system that may comprise a game software.

It is another objective of the present invention to provide a competitive game based character development system that may comprise a competitive game.

It is another objective of the present invention to provide a competitive game based character development system that may comprise a character development game.

It is another objective of the present invention to provide a competitive game based character development system that may comprise a rewards system.

It is another objective of the present invention to provide a competitive game based character development system that may comprise a purchasing system.

It is another objective of the present invention to provide a competitive game based character development system that may comprise a tournament system.

It is another objective of the present invention to provide a competitive game based character development system that may comprise a rankings system.

It is another objective of the present invention to provide a competitive game based character development system that may comprise a social networking system.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 schematically presents a competitive game based character development system, as contemplated by the present disclosure; and

FIG. 2 schematically presents a computing system configured to carry out and actualize methods and tasks described herein, in accordance with aspects of the present disclosure.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

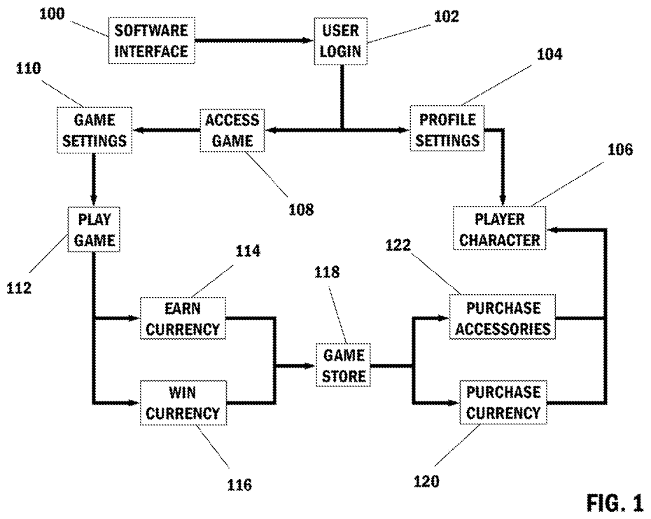

The illustration of FIG. 1 schematically presents a competitive game based character development system, as contemplated by the present disclosure. The system comprises, generally, a proprietary software, having a user interface on a computer or a mobile device, and which may be used to facilitate the playing of a game and the earning of reward points to develop a player's character. The system may comprise a plurality of user types, and may further associate a plurality of user settings with each of such user types. In one embodiment the system may comprise a trivia game related to hip hop trivia, and through which a player may earn rewards that can be used to purchase accessories from the game's store. These accessories may then be used to improve and develop the player's character, who may be a member of the hip hop industry.

To begin using the system a user may access the proprietary software by downloading it to a computer or mobile device, and may then log into the system. The log in process may involve the user selecting a unique user name and password and selecting a user type. The user types may include, for example, deejays, rappers, producers, moguls, or any other appropriate types. The user interface of the proprietary software may vary in available selections based on the user type selected. The user type may also be selectable or changeable based on the player's choices.

The competitive game based character development system may allow a user to earn in-game currency through the playing of various games within the system. The in-game currency may then be used to purchase accessories and upgrades for the user's character or profile. The games available within the system may be single player games or may be multiplayer games, and a competitive tournament style play may be integrated into the game setup.

By way of a first example, a first user may log in 102 to the software interface 100 of the system and set their user type as, for example, rapper. The first user may then establish a plurality of profile settings 104 associated with their user account, and may select a player character 106. The plurality of profile settings 104 may include any appropriate settings such as, for example, user name, age, location, gender, and any other appropriate settings. The player character 106 may comprise a profile image to be displayed on the user's profile page. The player character 106 may be selectable and editable, and may comprise representative images of persons from various races and genders that the user may choose to represent them within the system.

Once the user has established their profile settings 104 and chosen their player character 106, the user may access the game 108 of the system. The game may be any game appropriate to the competitive nature of the system. In one embodiment, the game may be a trivia game focusing on hip hop trivia. The user may establish game settings 110 related to the game to be played. The game settings 110 may include, for example, genre, era, decade, artist, artist location, or any other appropriate settings.

By way of example, a user may login 102 to the system and set up or access their profile, and may access the game 108 and set the game settings 110 for the game to be played. The user may set the game settings 110 for nineties-era rap music, and may then be presented with a series of trivia questions related only to nineties-era rap music. In an alternative example, the user may set the game settings 110 for all hip hop music from the Southern region of the United States, and may then be presented with a series of trivia questions related only to the selected region but across all eras of hip hop music. The user may also set the number of questions to be asked in a round or in the game, may set the timer for each of the questions, and may set the difficulty level of the questions to be asked.

Once the user has accessed the game 108 and set the game settings 110, the user may play the game 112 within the system. The game may be displayed to the user in any appropriate form such as, for example, the displaying of a question with multiple answer choices from which the user may select. The game may be displayed as a series of such questions randomly selected from a central database based on the game settings 110 entered prior to starting the game.

The objective of the game is for the user to acquire in-game currency, which may be represented as microphones, and with which the user may purchase accessories and upgrades for their player character. The user may earn currency 114 simply by playing the game, for example, receiving a small amount of microphones for each question interacted with in the game. The user may also win currency 116 by correctly answering questions within the game environment. The user may win more microphones by correctly answering questions than by incorrectly answering questions, and the microphone earning rate may be correlated to the difficulty of the question, with harder questions being worth a larger amount of currency.

The user exceeding a pre-determined threshold of correct answers through the course of the game round may also be awarded with in-game currency. For example, a user answering seventy-five percent of questions correctly may receive a small currency bonus, while a user achieving a perfect score within the round may receive a large currency bonus. The currency bonus may also be related to the length of the round, the number of questions asked in the round, or other user-selected game settings 110.

Once the user has acquired sufficient currency the user may access the system's game store 118 within the software interface 100. The user may also purchase currency 120 from within the game store, if desired. The in-game currency may be used within the game store 118 to purchase accessories 122 for the player's character 106. Such accessories may include any appropriate accessories such as, for example, clothing, jewelry, dance moves, body art, cars, entourages, businesses, or any other appropriate accessories.

The various accessories may vary in cost, and the purchasing of such accessories 122 may be correlated with an experience score. The accumulation of experience points through the purchasing of such accessories may allow a user to increase from one experience level to a higher experience level, and the increasing of experience levels may provide the user with access to more prestigious accessories. The various accessories, once purchased, may be applied to the user's player character 106 for display on the user's profile. In this way, the higher level and more experienced players will be able to display the most prestigious and expensive accessories within their profile. The in-game currency and the various accessories may also be purchased with actual currency through game store 118.

In an embodiment wherein the game is being played in a social setting, such as in a restaurant, bar, or other venue, the rewards system and in-game currency of the competitive game based character development system may be correlated with physical rewards or prizes. Such physical rewards of prizes may comprise any compensation appropriate to the particular venue. By way of example, if the game is being played at a tournament in a bar, the prizes may include drinks, appetizers, or food available from the bar. In a restaurant such prizes may similarly include food, drinks, or other accolades such as a certificate, ribbon, or wall placard. In any environment the prizes may be awards such as, for example, medals, ribbons, microphones, accolades, symbols of accolade, vouchers, credits, or other similar appropriate rewards.

The game style may be set as a single player game or as a multiplayer game. In an embodiment comprising a multiplayer game, the game may be presented in a tournament style of play wherein multiple users may compete directly for in-game currency and other prizes. One or more players may enter the tournament, which may require a certain level of experience or player level, and which may further require an entry fee of in-game currency or other credits. The one or more players may also be able to wager on the tournament game, so as to increase their potential awards through the competition. The game may then start with the multiple players, and the players may compete to correctly and most quickly answer the most questions. Once the tournament is completed, the winner of the tournament may receive a pre-determined in-game currency amount or an accessory prize, such as a special prize identifying that player as the winner of the tournament, within the system.

The system may further comprise a multiplayer game wherein a single user may challenge a second user to a game or battle. Where the tournament gameplay may involve a plurality of users competing for a pot or a single tournament prize, the battle system may allow two users to compete for smaller prizes or to wager on the battle in a winner-takes-all type of competition.

The user's profile within the system may keep a record of battle and tournament wins or losses, and may further incorporate a user ranking system based on scores and experience. The user's profile may further display the user's player character 106 image along with the various accessories purchased by the user for their character through the game store 118.

The system may also incorporate a social networking component that allows users to become friends with other users. A user may search for other users within the system by username, email address, or any other appropriate profile setting 104. The social networking component may allow one or more users to follow each other's progress or to join a team allowing for collaborative play. One or more teams of players may also engage in the various game battles and tournaments.

To protect the various user accounts, user data, and file exchanges it is contemplated that the competitive game based character development system may implement modern data security and encryption protocols. By way of example, the proprietary software may implement the advanced encryption standard (AES), the triple data encryption standard (3DES), the twofish standard, the Rivest, Shamir, Adelman standard (RSA), or any other appropriate encryption protocol. It is contemplated that the proprietary software may implement, at least, 128-bit encryption, though more difficult encryption, such as, for example, 192-bit or 256-bit, may be implemented as desired. The proprietary software may further comprise online identity verification protocols to ensure a user is authorized to access the various digital data stored in their system and to prevent the theft of such data.

The proprietary software may further comprise a bar code or similar scannable system to permit a user to share metadata parameters or digital media files among users. By way of example, a first user may set up a scannable code related to a particular event, competition, or tournament, which may be printed out or which may be displayed on the user's screen, and which may then be scanned by users so that they may join the event. In this way the event-specific parameters are automatically transmitted to other users.

In an embodiment comprising facial recognition technology for user identification and tagging, the competitive game based character development system may comprise software which may read a plurality of facial landmarks on a user's face. Such a software may use such facial landmarks to read the position of and changes in position of various facial muscles associated with facial expressions. Such a software may read facial expressions in still photos or may read facial expressions in real time. Utilizing such facial recognition software, the competitive game based character development system may identify persons by measuring certain facial features, namely the corners of the mouth, the corners of the eyes, the vertical position of the eyebrows, the prominence of the cheeks, the furrows of the forehead, or any other appropriate features.

In an embodiment comprising text-based input, the user may type queries and commands into the user interface using any appropriate input source, such as a physical or virtual keyboard or a smartphone or tablet device connected to the system, whether physically or wirelessly. In an embodiment comprising voice-based input the user may interact with the system using a microphone, whether individually or integrated into a smartphone or tablet device, and the system may comprise speech recognition and language interpretation components to understand and interpret the input.

Central to the application of speech recognition and language interpretation is the application of a natural language to structured commands convertor, which may be based on applying existing natural language processing concepts, to the user interface. Current natural language processors work by applying lemmatization and tokenization concepts to language inputs to extract the entities and intent of the given instruction. This process involves the analyzing of input terms and the analyzing of used syntax and inflection to determine blocks of entities in the input, and then converting those entities and intents into relevant structured commands. The present system may receive a natural language input from the user and automatically generate the appropriate command line instruction or sequence of command line instructions for the user interface.

In more detail, the system implements domain knowledge with natural language processing to achieve the desired results. Domain knowledge, as contemplated by the present disclosure, may include the user command sequences, configurations, and constraints relevant to the system. The natural language processor of the system converts the entities and intents of the user's input into the command-line instructions of the present system to manage digital file metadata, commands, and requests by applying such domain knowledge.

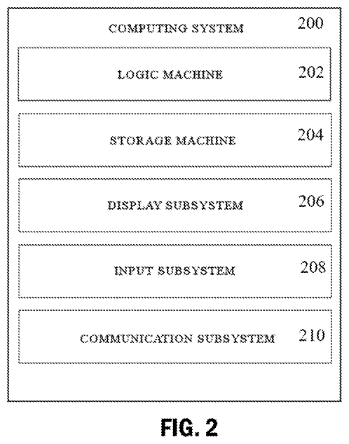

The illustration of FIG. 2 schematically presents a computing system that may represent an embodiment of the present invention. In some embodiments the method is executed on a computing system such as computing system 200. For example, storage machine 204 may hold instructions executable by logic machine 202 to provide the method to users.

Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above.

The described method may be executed, provided, or implemented to a user on one or more computing devices via a computer-program product such as via an application programming interface (API). Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210.

Logic machine 202 may execute machine-readable instructions via one or more physical devices. For example, the logic machine 202 may be configured to execute instructions to perform tasks for a computer program. The logic machine may include one or more processors to execute machine-readable instructions.

Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices.

Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A competitive game based character development system, comprising:
a proprietary software;
a user interface;
a plurality of user types;
a plurality of user settings;
a plurality of game types;
a central database;
an in-game currency; and
a digital store.

2. The invention of claim 1,
wherein said proprietary software displays said user interface on a display device of a computing system;
wherein said user interface allows a user to enter a plurality of inputs into said proprietary software via an input device of said computing system; and
wherein said user interface displays a plurality of queries to said user via said display device of said computing system.

3. The invention of claim 2,
wherein said proprietary software comprises a hip hop trivia game.

4. The invention of claim 3,
wherein one each of said plurality of user types is selected from the group consisting of a deejay, a rapper, a producer, and a mogul.

5. The invention of claim 4,
wherein one each of said plurality of game types is selected from the group consisting of a single player game, a multi player game, and a tournament game.

6. The invention of claim 5,
wherein said central database comprises a plurality of trivia questions.

7. The invention of claim 6,
wherein one each of said plurality of trivia questions comprises a music-related question.

8. The invention of claim 7,
wherein said in-game currency is awarded to said user according to a scoring protocol.

9. The invention of claim 8,
wherein said in-game currency is exchanged for a plurality of in-game rewards in said digital store.

10. The invention of claim 9,
wherein said in-game currency is exchanged for a plurality of actual rewards in a public tournament.
